(19) United States
(12) Patent Application Publication
(10) Pub. No.: US 2007/0139954 A1
(43) Pub. Date: Jun. 21, 2007

(54) Apparatus For Illuminating A Viewing Field, For Example An Object Field Under A Microscope

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 11/611,419

(22) Filed: Dec. 15, 2006

(30) Foreign Application Priority Data
Dec. 17, 2005 (DE) 10 2005 060 469.2

(51) Int. Cl. F21V 7/04

(52) U.S. Cl. 362/575; 362/551; 362/554

(57) ABSTRACT

The invention relates to an apparatus for illuminating a viewing field, for example a specimen (10) under a microscope (7), by means of at least two light sources (1a, 1b). The illumination apparatus comprises an apparatus for measuring the brightness of the light sources (1a, 1b). The result of this measurement can be transmitted to the observer (9), either acoustically or visually, via a computer (4) that compares the signal with a definable threshold value. The beam paths (103, 104) of the two light sources (1a, 1b) are guided via a combining light-guide coupler (109), a common light guide (2), and a separating light-guide coupler (111) having two light-guide arms (112, 15), one of the two light-guide arms (112) being delivered to the microscope (7) as a main light source, and the other light-guide arm (15) to a handpiece (16) as a second light source of the microscope (7). At least one of the two light sources (1a, 1b) is configured as a changeable unit (illumination changer), and at least one of the input light-guide arms (107, 108) is configured as a changeable unit (light-guide changer).

### CROSS REFERENCE TO RELATED APPLICATIONS

This application claims priority of German patent application no. 10 2005 060 469.2 filed Dec. 17, 2005, which is incorporated by reference herein.

### FIELD OF THE INVENTION

The present invention relates to an illumination apparatus, for example for a microscope.

### BACKGROUND OF THE INVENTION

With present usual illumination apparatuses for microscopes, in particular for surgical microscopes, halogen lamps are for the most part used for object-field illumination. These lamps on the one hand have a limited service life until total failure, and on the other hand the brightness of the lamp decreases because filament material becomes deposited over time on the lamp envelope. The present invention refers, however, to all types of light sources, such as e.g. halogen lamps, incandescent bulbs, xenon lamps, LEDs, laser light sources, etc.

In order to avoid excessive irradiation of the patient, U.S. Pat. No. 4,657,013 describes a dosimeter for patient protection. To protect against a total failure of the lamp during an operation, in the “VISU 200” of the Carl Zeiss company a lamp changer is used that, upon failure of the lamp, immediately switches over to a replacement lamp.

Operating hour counters are used to track the service life of xenon lamps, which are likewise used for microscope illumination systems. These counters are intended to allow operating personnel to change the lamp once a specific number of operating hours has elapsed, so that it does not fail unexpectedly.

The inventor has recognized that the known systems are disadvantageous with regard to the following points:
Once a specific lamp service life has been reached, the operator (surgeon) complains of a lack of brightness in the surgical field, even though all the supply systems (electronics, light guides, optical coupling into the microscope) are OK.
Information in the operating instructions that describes this effect is seldom noted in practice, or is also often not consciously recalled at the critical moment during a hectic surgical procedure.
In order to compensate for the loss of brightness, the voltage as a rule is simply increased by turning up a potentiometer or light controller. In cases where a lamp changer is used, this can result in a brightness shock when a lamp change occurs, since the increased voltage makes the new lamp substantially brighter. In the field of ophthalmology, this can result in damage to the patient's eye.
With the exception of the operating hour counter system, it is not possible for maintenance personnel to predict when a lamp should be replaced before it fails at an inconvenient time.
Operating hour counters are designed only for average lamp outputs, and do not indicate the actual need for a lamp change.

Illumination of an object field by means of two light sources is increasingly being used in a variety of applications, since the specimen can thereby be illuminated with different light-wave spectra, e.g. UV and/or white light, and/or from different directions. The former is applicable especially for applications in dental medicine, in which light of specific wavelengths is used to polymerize plastics.

Illumination changers having two lamps in the arrangement described allow a burned-out lamp to be replaced with a reserve lamp, so that the interruption that occurs in the event of a lamp failure is as short as possible.

A configuration in accordance with an M500™ surgical microscope of the assignee is known in the field of surgical microscopy; in this configuration a microscope and an illumination apparatus of the species are mounted on a stand, and a light guide extends between the illumination apparatus and the microscope. Two lamps are located on a pivotable carrier that can be pivoted from outside by means of a rotary handle, so that a switchover occurs from one lamp to the other by the fact that the lamp is pivoted away from the light guide and the other is pivoted in front of it.

The light guides can be configured as individual light guides, but also as a common light guide having multiple light-guide arms that are combined into one common arm by means of a combining light-guide coupler, and split again using a separating light-guide coupler. Light guide arrangements of this kind are known to one skilled in the art and are manufactured, for example, by the Schott company (Germany).

In addition, spectral filters are used in the illumination apparatus according to the present invention. Spectral filters serve to exclude damaging or undesired light wavelengths. In various known illumination apparatuses, such filters are mounted exchangeable or on a carrier so that they can be pivoted or slid in front of the light guide or the lamp as necessary. The filter itself is movable, and readily exchangeable with other filters.

Filter retainers that permit changing of the filters are known per se, including in illumination apparatuses. The “VISU 2000” encompasses a lamp retainer having a pivotable base for changing lamps, and a filter retainer that has a rotatable disk with orifices in which the exchangeable filters are inserted. The disk is held on a shaft on the housing rotatably in a plane perpendicular to the light guide, so that different filters can alternately be brought in front of the light guide by rotating the disk. The rotation is brought about by a linkage that extends below the pivotable lamp retainer and is connected to a rotary knob outside the housing. The base of the lamp retainer is pivotable in a plane perpendicular to the disk having the exchangeable filters. There is therefore an entirely separate structure both for the lamp retainer and for the filter retainer, the two lamp retainers having mutually independent operating elements and linkages.

The following documents are cited as additional existing art:
CH 495530A 1969 Pivotable lamps;
DE 1489516 1965 Rotary lamp changer;
U.S. Pat. No. 3,136,920 1964 Power failure indicator;
U.S. Pat. No. 3,269,795 1964 Pivotable lamp changer;
U.S. Pat. No. 3,678,286 1972 Automatic electronic lamp changer
U.S. Pat. No. 3,832,539 1974 One lamp shines into two beam paths;
U.S. Pat. No. 4,110,820 1978 Reserve lamp not electrically connected;
U.S. Pat. No. 4,399,358 1983 Different pivoting solutions and mirror design, but relating to a different field
U.S. Pat. No. 4,402,038 1983 Pivoting apparatus in signal lamps, without filter;
U.S. Pat. No. 4,673,824 1987 Power monitoring circuit;
U.S. Pat. No. 4,751,398 1988 Power monitoring system, emergency illumination system for building;
U.S. Pat. No. 5,023,515 1991 Power monitoring circuit for lamp according to U.S. Pat. No. 5,032,962;
U.S. Pat. No. 5,032,962 1991 Lamp changer for operative lamps with lever mechanism for moving replacement lamp into operative reflector focal point;
U.S. Pat. No. 5,406,416 1995 Earlier approach by the Application, with rotatable changeable lamp retainer but without filter.

The inventor has recognized that the known systems are disadvantageous in terms of the following points:
Apparatuses of this kind generally require two separate illumination systems that are wired and manipulated independently of one another.
The handpiece of the second light source is independent of the microscope, so that it must be brought manually to, for example, the location requiring polymerization. This results in complex manual manipulation of the second light source, and usually requires an assistant if the doctor him- or herself wishes to perform other actions.
The fact that the individual light sources are independently switchable increases the operating complexity of the individual light sources.
It is not possible to change easily between the two illumination systems, with the result that, for example, with the one illumination system only UV light is available, thus making exact positioning difficult or impossible because UV light is invisible.
With the existing illumination apparatuses the speed of a light-source change, for example upon failure of a lamp, is capable of improvement.
The known illumination apparatuses having changeable filters contain a complex linkage for filter retention, and the entire construction thus has a relatively large overall volume.

### SUMMARY OF THE INVENTION

One portion of the object of the invention is thus to create an apparatus that monitors the light source, for example a halogen lamp, over the entire service life and indicates early on, to the surgeon or to maintenance personnel, the need for a lamp change, without having to count operating hours.

This first portion of the object is achieved by way of the apparatus described below.

The actual light output of the lamp is monitored by means of one or more monitoring sensors. The decrease in lamp output over its time in service indicates to the sensor when the lamp is approaching a critical phase. The fact that the critical phase has been reached is signaled to the user or to maintenance personnel.

With presently usual illumination apparatuses, the light, often generated by cold-light mirror lamps, is focused onto a light-guide input. The light guide transports the light via an optical system in the microscope to the surgical field. The actual light cone of the cold-light lamp is, however, larger than the light-guide input, although lower in luminance toward the edge. According to the present invention this portion of the light cone is utilized by a light sensor that is located next to the light guide, and is continuously measured in terms of brightness.

The sensor's signal is delivered in conventional fashion to a signal-processing electronic system. When a threshold in terms of light reduction or increase is reached, said threshold preferably being unrestrictedly selectable and settable on the computer, an optical indicator and/or an acoustic signal is activated. The optical indicator can be embodied, for example, as a flashing red signal light or as a reading on an instrument, preferably on the lamp electronics of the microscope. The optical indicator preferably encompasses an input, e.g. in the form of a rotary knob or a keypad, with which the threshold value can be inputted. It is also possible to make the indicator visible to the operator directly in the intermediate image of the surgical microscope, via a known superimposition apparatus. An indication is thereby given, for example, that the quantity of light emitted is no longer sufficient for surgery, and a lamp change should be performed. It is then possible, for example, to operate a lamp changer, or the lamp can also be replaced in conventional fashion. The signal can also be used to control the lamp change automatically.

As an alternative thereto, provision can be made to arrange at least two lamps in immobile fashion, one lamp being used as a working lamp and the other as a reserve lamp. When the signal-processing electronic system then measures the preselected threshold value, provision is made for the input of the light guide to be shifted or rotated, manually or automatically, from the working lamp to the reserve lamp. The advantage of this alternative approach is that substantially smaller masses and smaller volumes are moved.

As a particular development, a calibration apparatus is integrated into the electronics unit, allowing the measured value for a new lamp to be set to a value of 100% and the threshold value for light reduction then to be inputted as a percentage, for example 60%. The corresponding measurements and calculations by the electronic system are based on the regulated voltage that is optionally present, in order to make the measurements and calculations more objective. The result is that when a lamp change is necessary, the intensity of the reserve lamp can be set to a continuous power rating. If the new lamp does not achieve the power rating (self-check), it is replaced by another one.

In a further exemplifying embodiment, the light sensor is arranged behind the cold-light mirror of the lamp rather than next to the light guide. Because the cold-light mirrors that are used reflect only in the visible range but allow light to pass in the remainder of the spectrum, a measurement is possible here as well (albeit in a different spectral region). Because the intensity in this spectral region nevertheless corresponds to the light output at the filament, this preferred configuration is well suited for measuring the condition of the light source.

The following improvements are achieved as a result of the above-described features of an illumination apparatus utilizing an apparatus for monitoring the light source:
The observer is promptly informed when the light intensity of the light source no longer corresponds to the initial intensity, or has approached or reached a predetermined threshold value.
An early signal as to when the lamp is approaching total failure.
Ability to replace the lamp before total failure, constituting an additional safety aspect.
Self-check of the microscope's illumination apparatus.
Ability to keep the illumination intensity constant, by means of a control loop, over a specific portion of the lamp's service life.
Ability to switch the light guide (or multiple light guides) from a lamp that is about to fail to an intact reserve lamp.

A further variant embodiment of an illumination apparatus according to the present invention contains multiple light sources as well as multiple light guides and multiple spectral filters.

A further object is therefore to create an apparatus that permits illumination of an object field by means of two light sources which are simultaneously controlled and/or manipulated in common fashion, and that avoids the disadvantages indicated.

This further object is achieved by combining the beam paths of the two light sources via two respective separate light guides that terminate, via a light-guide coupler, at a light guide guided in common fashion. This common light guide leads into a separating light-guide coupler that releases the common light guide back into the two separate light guides. The two light guides are delivered separately to a microscope as a main illumination system and, for example, to a handpiece as a second illumination system.

This apparatus is usable regardless of whether the light contains different wavelength regions or is used in pulsed or time-limited fashion, or whether the light is guided to the combining light-guide coupler via light guides or via an optical system, or whether spectral filters are interposed between the light sources and the light guide, or whether the light sources are arranged changeably or exchangeably, for example to allow UV illumination through the microscope objective or white light as a second illumination through the handpiece.

A further principal feature of an illumination apparatus according to the present invention is an illumination changer that has the following properties:
the illumination apparatus is intended, to the extent possible, to be integrated into a contained overall structure, and to be compact;
the operating elements for actuating the lamp retainers and filter retainer are intended to be easily accessible by the user;
the operating elements are intended, with a view toward greater robustness, to be connected as directly as possible (avoiding linkages and the like) to the parts of the changing apparatuses that are to be moved.

These properties can be attained by an illumination changer that, in a first variant, is embodied as follows:

At least one of the light sources is embodied as a changeable unit having two concentrically rotatable individual light sources, and the changeable filters are arranged rotatably concentrically with the light sources.

In addition, operating elements engage (preferably via shafts) directly onto the respective retainers, so that linkages or the like are omitted and robustness is ensured.

This illumination changer can be implemented in a number of further variants:
One variant likewise provides for two concentric retainers, but in contrast to the first variant a lamp retainer for pivoting the lamps is not provided and instead the lamps are fixedly mounted. The input of the light guide, on the other hand, is mounted on a pivotable holder. This construction eliminates movement of the lamps, simultaneously allowing rapid changing of the illumination.
A further variant embodiment replaces both the pivoting capability of the lamps and the pivoting capability of the light guide, by the fact that instead an optical component(s), e.g. mirrors, prisms, optical systems, or the like, are arranged pivotably in such a way that their pivoting results in a switchover of the light path from the one fixed lamp to the fixed light guide, to the other fixed lamp to the same fixed light guide.
Also conceivable, with the same optical component, is a variant embodiment in which the light paths of two or more fixedly arranged lamps are selectably pivotable onto the one or the other arm of the double light guide.
A further variant embodiment is an alternative to the one just mentioned, in that in it the optical components are arranged not in pivotable but in linearly displaceable fashion.

The use according to the present invention of an apparatus for illumination of a viewing field by way of two light sources each having a beam path, which are delivered by means of two light guides or one combining light-guide coupler via a common light guide and a separating light-guide coupler to a microscope as a main illumination and to a handpiece as an additional illumination, yields the improvements listed below:
It is possible to construct a common illumination system whose light sources are controlled and switched individually and/or together.
The two illumination systems of the microscope are integrated into a common housing, for example on the stand of a microscope, thereby improving practical manipulation.
The use of a common light guide as a connection from the light sources to the microscope and handpiece allows a compact configuration.
Light sources with different spectral regions are usable; in addition, different spectral regions can be selected, for example by using filters, for each individual light source.
The handpiece is attachable to the microscope, for example by means of a gooseneck.
Filters are insertable, as necessary, between the light sources and the combining light-guide coupler.
The light sources can, as necessary, be controlled differently, e.g. in pulsed or time-limited fashion.
In accordance with a particular embodiment, the two main light sources are arranged exchangeably, so that it is possible to associate one of the two light sources alternately with the microscope and the handpiece, thus simplifying exact positioning of the handpiece in particular.

As a result of the particular development of the invention, or the use of an illumination changer according to the present invention, in the context of at least one of the two light sources, the following improvements are additionally achieved:
A very rapid lamp change is possible, for example upon failure of a lamp.
A filter system having different spectral filters can be integrated into a small space.
The elimination of linkages or the like results in excellent robustness and low adjustment resistance.
Variants having fixedly arranged lamps reduce mechanical stresses on the lamps (due to vibration) for the same changing capability, thereby increasing their service life.

The particular development of the invention, namely the illumination changer, is not limited to the embodiments described in the Claims or the drawings. It encompasses all those variants and configurations that one skilled in the art can imagine after studying this Application and with a knowledge of the existing art. In particular, for purposes of the invention “concentric” is also to be understood as “parallel,” and “pivoting” also as “displacement.” This may be explained by the fact that for this invention, a straight line is understood as a curve of infinite radius. Two changeable light sources and three changeable filters are depicted in each of the exemplifying embodiments. The invention is, however, not limited to a specific number of light sources or filters.

Specifically, a further preferred variant embodiment of an illumination apparatus according to the present invention provides for a combining light-guide coupler to be arranged displaceably in front of a pair of light sources. It is a matter of course in this context, as a further preferred variant, to arrange the above-described combining light-guide coupler in front of three or indeed more light sources. The light-guide coupler can thus, upon failure of a light source, be shifted to a different pair of light sources.

For displacement of the light sources or light guides, it is a matter of course to implement an electromechanical control system. This electromechanical system provides a manual intervention capability.

Assisted by an electronic unit. e.g. a computer, the measured signals of the sensors with regard to the lamp condition can be used to automatically generate a displacement of the lamps or a displacement of the light-guide coupler. The same electromechanical system can also be configured to displace filters that are arranged in front of the inputs of the light-guide coupler.

A variant embodiment that is also preferred provides for the lamps or filters or light guides to be displaceable by means of the electromechanical system not only in pairs, but also individually.

Although reference was made in the text above to a surgical microscope, the invention is not limited thereto but instead is also open to other users of optical devices having an illumination apparatus or having two different illuminations in the object field. The Claims are to be construed correspondingly broadly.

The arrangement having an additional microscope illumination in the form of a movable handpiece is not obligatory. Also conceivable are variant embodiments in which a second light guide or a second light-guide arm serves the microscope as a second, additional, immovable illumination system arranged externally or internally on or in the microscope body. This is helpful especially with regard to certain applications in which, for example, white and UV light is desired alternately and/or simultaneously.

### BRIEF DESCRIPTION OF THE DRAWINGS

Further embodiments of the invention are evident from the Figures and from the dependent Claims. The Parts List is a constituent of the disclosure. The invention is explained in more detail, symbolically and by way of example, with reference to Figures, which are described continuously and interconnectedly. Identical reference characters denote identical components; reference characters having different indices indicate identically functioning or similar parts.

In the Figures:

FIG. 1 schematically depicts an illumination apparatus having a light guide;

FIG. 2 schematically depicts an illumination apparatus according to the present invention having two light-guide couplers;

FIG. 3 shows the symbolic construction of a system having two light sources that are imaged via a lens system onto a combining light-guide coupler;

FIG. 4 shows attachment of the handpiece to the microscope by means of, for example, a gooseneck;

FIG. 5 schematically depicts the physical construction of an illumination changer;

FIG. 6 schematically depicts the pivotable holding plates of the illumination changer depicted in FIG. 5; and

FIG. 7 is a side view of the illumination changer depicted in FIG. 5.

### DETAILED DESCRIPTION OF THE INVENTION

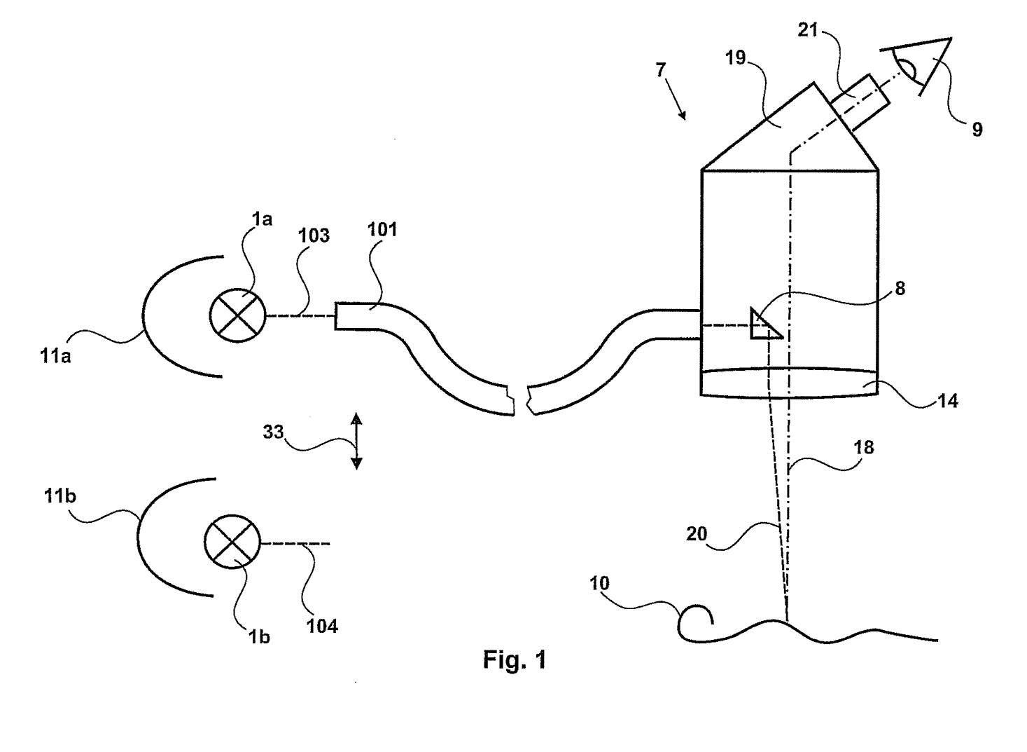

FIG. 1 shows the schematic construction of an illumination apparatus for a microscope 7, for example a surgical stereomicroscope, having a first light source 1a and a second light source 1b, and having cold-light mirrors 11a and 11b that generate a first beam path 103 and a second beam path 104. A light guide 101 is positioned so that it can receive, for example, first beam path 103. With its output end, light guide 101 is delivered to microscope 7. Microscope 7 is depicted above a specimen 10 from which images are delivered along microscope beam paths (depicted by a microscope axis 18) through a main objective, a tube 19, and eyepieces 21, to an observer. The observer is depicted symbolically by an eye 9. The illumination beam path that leaves the output end of light guide 101 is deflected by means of a deflecting prism 8 to a coaxial illumination beam path 20. The input end of light guide 101 is displaceable from beam path 103, along a displacement direction 33, to beam path 104. Instead of one light guide 101, two or more light guides can also be provided, which are arranged displaceably in front of light sources 1a and 1b.

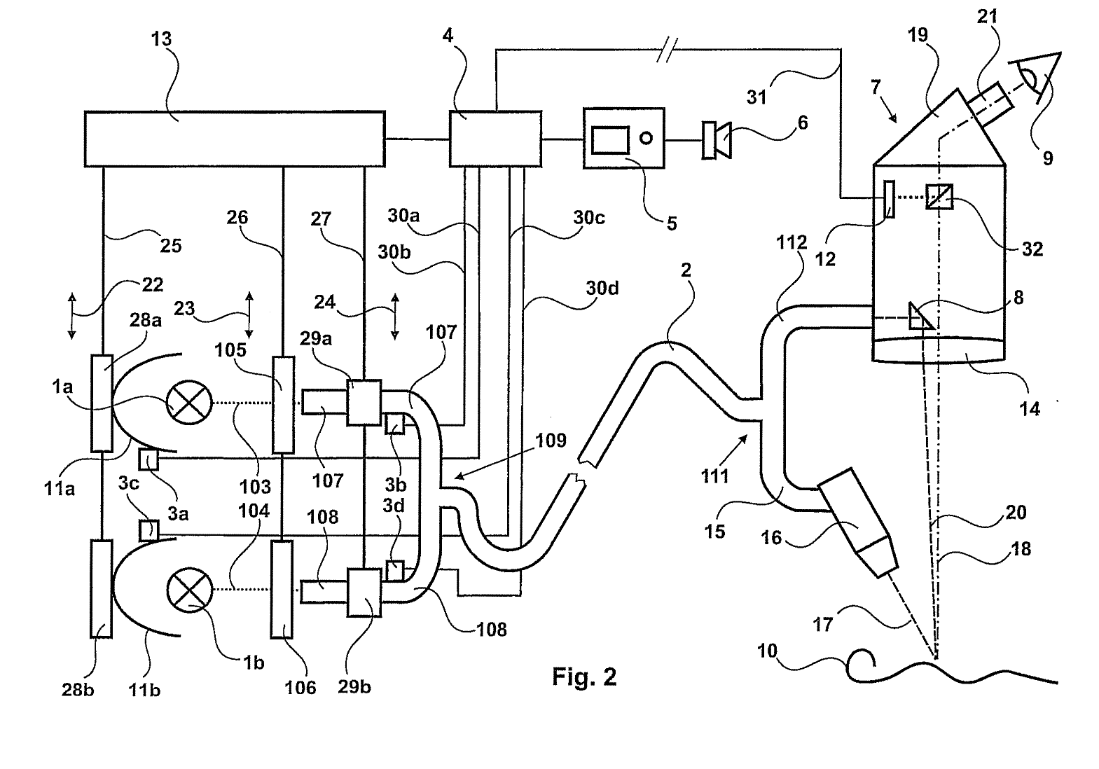

FIG. 2 shows the arrangement from FIG. 1 with a light guide 2 having a combining light-guide coupler 109 having light-guide arms 107 and 108 and a separating light-guide coupler 111. Also depicted are light sensors 3a-d for measuring the intensity of the light generated by light sources 1a and 1b, a computer 4, leads 30a-d from light sensors 3a-d to computer 4, an indicator 5, and an acoustic signal generator 6. FIG. 2 furthermore shows a deflecting prism 8, an indicator unit 12, and a superimposition unit 32 for superimposing the image information of indicator unit 12 onto one or both microscope beam paths. The latter correspond to microscope axis 18 that is depicted. What is therefore depicted is the fact that the image of a specimen 10 is delivered, together with the superimposed image information of indicator unit 12, to an observer depicted symbolically by eye 9.

Light sensors 3a-d can be arranged simultaneously at the attachment locations depicted, or in pairs at light sources 1a and 1b or light guides 107 and 108. The invention also encompasses variants in which the light sensor is arranged on or in the vicinity of main objective 14 or handpiece 16 in the light cone of the illumination, in order also to take into account any influences of the light guide.

Acoustic signal generator 6 that is depicted can have any desired embodiment; one energetically favorable embodiment is, for example, a piezoelectric buzzer.

Indicator unit 12 and acoustic signal generator 6 can be provided together or alternatively. The attachment location of these components is selectable based on the user's requirements; it can be directly on or in microscope 7, or also directly on the housing of the illumination apparatus.

The light generated by light sources 1a and 1b is concentrated via cold-light mirrors 11a and 11b onto light guides 107 and 108. Because this concentration does not occur entirely onto the input surface of light guides 107 and 108, the intensity of light sources 1a and 1b can be sensed, next to light guides 107 and 108, via light sensors 3b and 3d. This sensing is converted into electrical signals and delivered via leads 30b and 30d to computer 4. Inside this computer 4, these signals are compared with a definable threshold value. If the value exceeds or falls below this threshold, this circumstance is communicated to user 9 by means of indicator 5 and/or an acoustic signal (acoustic signal generator 6) and/or indicator unit 12 in microscope 7. User 9 then decides whether he or she wishes to immediately change a light source 1a or 1b having a critical value, or to continue working for a while and then change the light source (lamp) manually, or manually or automatically via a lamp changer.

In a variant of the arrangement described above, light sensors 3a and 3c are arranged on the back side of cold-light mirrors 11a and 11b. Because cold-light mirrors 11a and 11b reflect only the visible wavelength regions but not those in the non-visible region, an intensity measurement is possible here as well.

As a further embodiment, computer 4 is connected to light sources 1a, 1b (connection not shown in FIG. 2) to form a control loop in order to keep the light intensity of light sources 1a and 1b constant over a specific portion of the service life, based on signals from the light sensors associated with the light sources. As a result, sufficient light intensity on the specimen is always available to the user, as a function of the threshold value selected by him or her.

Beam paths 103 and 104 emanating from the two light sources 1a and 1b are delivered via light guides 107 and 108 to combining light-guide coupler 109. The combined beam paths are delivered via a common light guide 2 to a separating light-guide coupler 111. The one light-guide arm 112 of separating light-guide coupler 111 supplies the main illumination system of microscope 7; the other light-guide arm 15 of separating light-guide coupler 111 supplies handpiece 16. The second light source of microscope 7, embodied as handpiece 16, illuminates specimen 10 with its illuminating beam path 17.

Handpiece 16 can be mounted on microscope 7, for example by means of a gooseneck 16a.

The two light sources 1a, 1b can be arranged shiftably or changeable, and/or can be used in pulsed or time-limited fashion. It is additionally possible to interpose changeable filters 105, 106 into the respective beam paths 103, 104. Light guides 107 and 108 are likewise arranged displaceably.

The two light sources 1a, 1b and light guides 107 and 108 can be displaced both manually and automatically by means of the sensor-controlled electromechanical system 13. For this, sensors 3a-d continuously measure the intensity of light sources 1a and 1b and deliver the signal of this measurement to computer 4; and if this value exceeds or falls below a previously defined threshold, computer 4 delivers to electromechanical system 13 an instruction for a corresponding displacement. Displacement directions are labeled with reference characters 22-24. Light sources 1a and 1b can be displaced by means of a displacement apparatus 25 that is connected to a retainer 28a and 28b for light source 1a and respective cold-light mirror 11a, and light source 1b and respective cold-light mirror 11b. Displacement apparatus 26 can generate a displacement 23 of changeable filters 105 and 106. Filters 105 and 106 can thus be introduced into beam paths 103 and 104, respectively, either manually or under the control of computer 4. A displacement apparatus 27 is connected to retainers 29a and 29b that respectively hold light-guide arms 107 and 108. Electromechanical system 13 displaces light-guide arms 107 and 108. This displacement 24 can be accomplished in such a way that the input of light-guide arm 108 comes to rest in front of beam path 103. The input of light-guide arm 107 can come to rest in front of a third beam path (not depicted) of a third light source.

Provision is additionally made, in order to inform the operator visually as to the condition of light sources 1a, 1b by way of warning signals in the field of view of microscope 7, for computer 4 to supply the corresponding information to indicator unit 12 via control leads 31. This information is superimposed, via superimposition unit 32, into one or both stereo beam paths of microscope 7 (depicted by microscope axis 18), so that the operator sees the visual notification in addition to the microscope image.

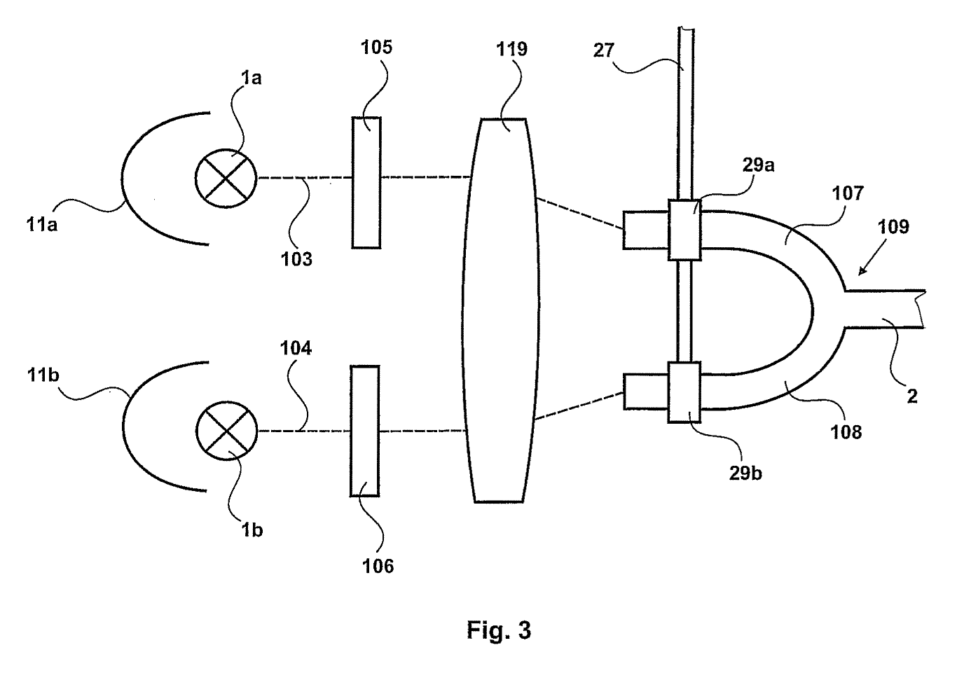

FIG. 3 schematically shows two light sources 1a and 1b having cold-light mirrors 11a and 11b, beam paths 103 and 104 of the two light sources 1a and 1b, changeable filters 105 and 106, and the light guide arrangement with combining light-guide coupler 109, as shown in FIG. 1. An optical system 119, which can be made up of Fresnel lenses but also of conventional lenses or diffractive elements, is symbolically depicted. This optical system 119 concentrates beam paths 103 and 104 onto the inputs of light-guide arms 107 and 108. A particular configuration (not depicted in further detail) of this optical system 119 (e.g. a pivotable prism system) can cause, for example, beam path 104 to be assigned to light-guide arm 107 and beam path 103 to be assigned to light-guide arm 108. Also conceivable in this context are arrangements having more than the two light-guide arms 107 and 108 that are depicted.

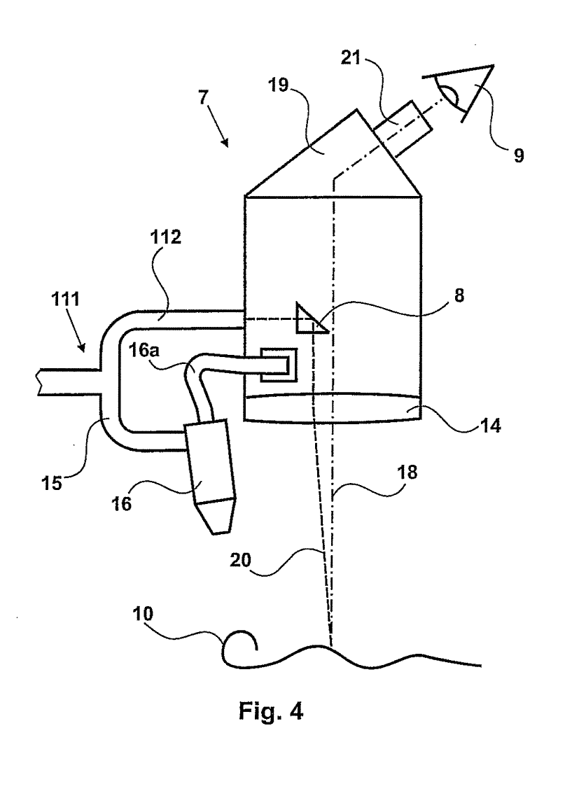

FIG. 4 symbolically shows, with reference to a microscope arrangement according to FIG. 2, the mounting of a handpiece 16 directly on microscope 7, for example by means of a gooseneck 16a.

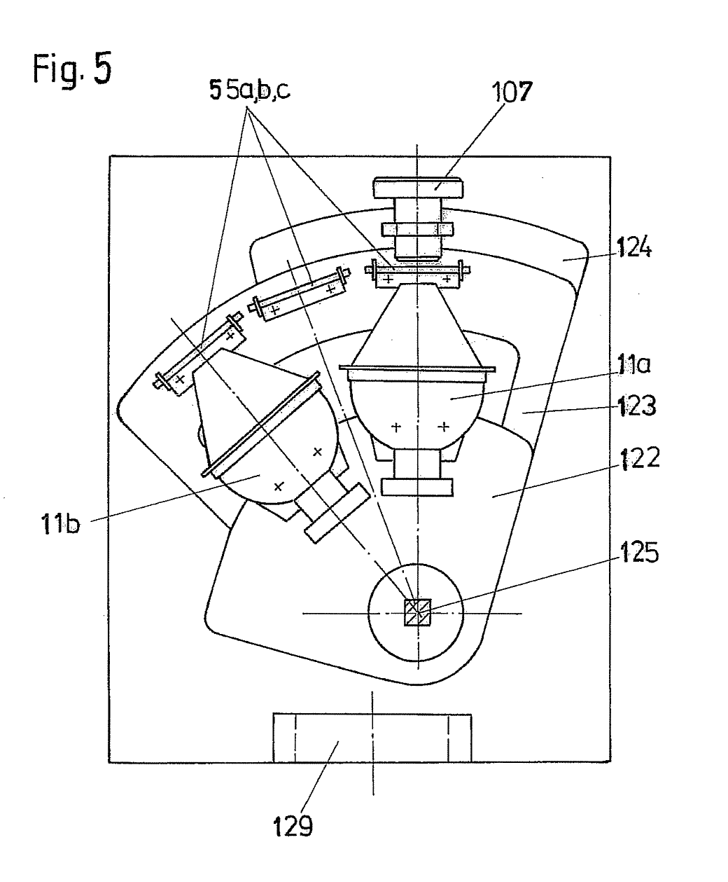

FIG. 5 schematically shows the construction of an illumination changer. The numbers 11a and 11b depict two cold-light mirror lamps as light sources, filters 55a-c being placed in front of them. The Figure furthermore shows a holding plate 122, rotatable about an axis 125, for the light sources; a coaxially rotatable holding plate 123 for filters 55a-c; and a coaxially rotatable holding plate 124, which can be provided as an alternative, for light guide 107. An optional retainer for a cooling fan 129 is furthermore depicted.

The two light sources are arranged on a holding plate 122, coaxially rotatably about an axis 125. Filters 55a-c and light guide 107 are arranged to be individually rotatable about the same rotation axis 125. Because of these arrangements, any desired combinations of illumination and filter are possible by rotation of the individual systems.

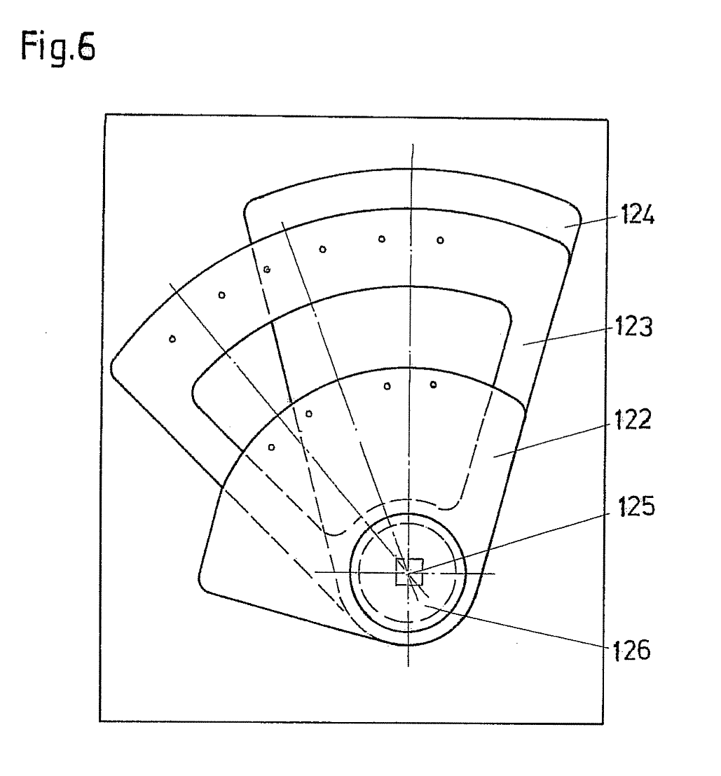

FIG. 6 schematically shows the configuration of movable holding plates 122, 123, and 124, depicted in FIG. 5, for the light sources, the filters, and the light guide. The Figure shows a rotary knob 126 for actuation/rotation of the holding plates about axis 125. Rotary knob 126 can be manually raised or lowered, as is known per se, so that it can be selectably brought into engagement with one of plates 122, 123, or 124, and thus acts as a multifunctional operating knob. A variant embodiment (not depicted in further detail) provides for electromechanical system 13 to control rotary knob 126 in electrically motorized fashion.

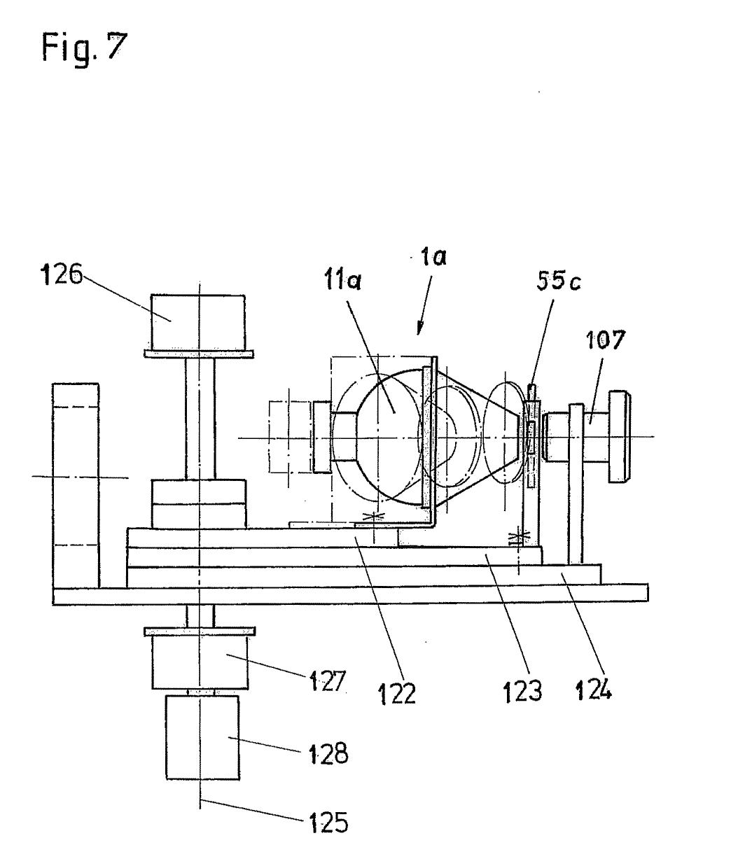

FIG. 7 is a side view of the illumination changers depicted in FIG. 5 and FIG. 6, additionally having respective rotary knobs 127 and 128 for actuating holding plates 123, 124 of filters 55a-c (only filter 55c is visible) and of light guide 107. With this configuration, a rotary knob 126 is provided for light sources 1a, 1b (only one light source is recognizable by its cold-light mirror 11a), while a rotary knob 127 is provided for filters 55a-c. The light guide can be pivoted by means of a separate, coaxially mounted rotary knob 128. In this variant embodiment, rotary knobs 126, 127, and 128 are therefore not multifunctional.

### PARTS LIST

1a, b Light source
2 Light guide
3a-d Light sensor
4 Electronic unit, computer
5 Indicator
6 Acoustic signal generator
7 Microscope
8 Deflecting prism
9 Observer
10 Specimen
11a, b Cold-light mirror
12 Indicator unit
13 Electromechanical system
14 Main objective
15 Light-guide arm to 16
16 Handpiece
16a Gooseneck
17 Illumination beam path
18 Microscope axis
19 Tube
20 Illumination beam path
21 Eyepiece
22 Displacement of 1a, b
23 Displacement of 105, 106
24 Displacement of 107, 108
25 Displacement apparatus for 1a, b
26 Displacement apparatus for 105, 106
27 Displacement apparatus for 107, 108
28a Retainer for 11a and 1a
28b Retainer for 11b and 1b
29a, b Retainer for 107 and 108
30a-d Leads from 3 to 4
31 Control lead
32 Superimposition unit
33 Displacement movement of 101
55a-c Filter
101 Light guide
103 Beam path of 1a
104 Beam path of 1b
105 Changeable filter for 103
106 Changeable filter for 104
107 Light-guide arm for 103
108 Light-guide arm for 104
109 Light-guide coupler (combining)
111 Light-guide coupler (separating)
112 Light-guide arm to 7
119 Optical system
122 Holding plate
123 Holding plate
124 Holding plate
125 Axis
126 Rotary knob
127 Rotary knob
128 Rotary knob
129 Retainer for cooling fan

What is claimed is:

1. An apparatus for illuminating a viewing field of an optical viewing device, the apparatus comprising:
a first light source (1a) having a first beam path (103) extending therefrom;
a second light source (1b) having a second beam path (104) extending therefrom; and
at least one light guide having a light entrance end for receiving an illumination beam and a light exit end through which the illumination beam passes as the illumination beam is directed to the optical viewing device or to an object observed through the optical viewing device;
wherein the light entrance end of the at least one light guide is displaceable relative to the first and second beam paths to position the light entrance end either in the first beam path to receive an illumination beam from the first light source or in the second beam path to receive an illumination beam from the second light source.

2. The illumination apparatus according to claim 1, wherein the at least one light guide includes a first light guide and a second light guide, wherein a light entrance end of the first light guide is positioned in the first beam path and a light entrance end of the second light guide is positioned in the second beam path when the apparatus is in a normal operating state.

3. The illumination apparatus according to claim 2, wherein the first light guide includes a first light-guide arm (107), the second light guide includes a second light-guide arm (108), the first and second light-guide arms are combined by a light-guide coupler (109) into a common light guide (2), the common light guide (2) leads to a separating light-guide coupler (111) which separates the common light guide (2) into a third light-guide arm (112) forming part of the first light guide and a fourth light-guide arm (15) forming part of the second light guide, the third light-guide arm (112) being delivered to the optical viewing device (7) as a first illumination light source, and the fourth light-guide arm (15) being delivered to the optical viewing device (7) as a second illumination light source.

4. The illumination apparatus according to claim 2, further comprising a retainer (28a, 28b) carrying the first light source (1a) and the second light source (1b), and a displacement apparatus (25) connected to the retainer (28a, 28b) for displacing the retainer relative to the first light guide and the second light guide.

5. The illumination apparatus according to claim 2, further comprising a retainer (29a, 29b) carrying the light entrance end of the first light guide and the light entrance end of the second light guide, and a displacement apparatus (27) connected to the retainer (29a, 29b) for displacing the retainer relative to the first and second beam paths.

6. The illumination apparatus according to claim 2, further comprising a filter pair (105, 106) including a first filter (105) inserted in the first beam path (103) between the first light source (1a) and the light entrance end of the first light guide and a second filter (106) inserted in the second beam path (104) between the second light source (1b) and the light entrance end of the second light guide, and a displacement apparatus (26) connected to the filter pair (105, 106) for displacing the filter pair relative to the first and second beam paths.

7. The illumination apparatus according to claim 2, further comprising:
a first retainer (28a, 28b) carrying the first light source (1a) and the second light source (1b), and a first displacement apparatus (25) connected to the first retainer (28a, 28b) for displacing the first retainer relative to the first light guide and the second light guide;
a second retainer (29a, 29b) carrying the light entrance end of the first light guide and the light entrance end of the second light guide, and a second displacement apparatus (27) connected to the second retainer (29a, 29b) for displacing the second retainer relative to the first and second beam paths; and
a filter pair (105, 106) including a first filter (105) inserted in the first beam path (103) between the first light source (1a) and the light entrance end of the first light guide and a second filter (106) inserted in the second beam path (104) between the second light source (1b) and the light entrance end of the second light guide, and a third displacement apparatus (26) connected to the filter pair (105, 106) for displacing the filter pair relative to the first and second beam paths.

8. The illumination apparatus according to claim 7, further comprising:
an electromechanical system (13) connected to the first displacement apparatus (25), the second displacement apparatus (26), and the third displacement apparatus (27) for controlling the first displacement apparatus (25), the second displacement apparatus (26), and the third displacement apparatus (27); and
a computer (4) connected to the electromechanical system (13) for providing control signals to the electromechanical system (13).

9. The illumination apparatus according to claim 8, further comprising at least one light sensor (3a-d) arranged to detect the intensity of light emitted by the light sources (1a, 1b), and an indicator (5, 6, and/or 12) connected to the at least one light sensor (3a-d).

10. The illumination apparatus according to claim 9, wherein the at least one light sensor (3a-d) and the indicator (5, 6, and/or 12) are connected to the computer (4), and the computer (4) stores threshold values of illumination intensity of the light sources (1a, 1b), the threshold values being definable by a user.

11. The illumination apparatus according to claim 10, wherein the indicator (5, 6, and/or 12) includes an indication device chosen from a group of indication devices consisting of an acoustic signal generator (6), a display, and a light source.

12. The illumination apparatus according to claim 11, wherein the indicator includes a display (12) arranged such that and image of the display can be superimposed into a beam path of an optical viewing device with which the illumination device is associated.

13. The illumination apparatus according to claim 10, wherein the computer (4) is connected to the first and second light sources (1a, 1b) to form a control loop that keeps the illumination intensity of the first and second light sources (1a, 1b) constant.

14. The illumination apparatus according to claim 9, wherein the at least one light sensor includes a first light sensor (3b) arranged next to the first light guide and a second light sensor (3d) arranged next to the second light guide.

15. The illumination apparatus according to claim 9, further comprising a first cold-light mirror (11a) associated with the first light source (1a) and a second cold-light mirror (11b) associated with the second light source (1b), and the at least one light sensor includes a first light sensor (3a) arranged behind the first cold-light mirror (11a) and a second light sensor (3c) arranged behind the second cold-light mirror (11b), wherein the first and second light sensors (3a, 3c) measure the intensity of the light spectrum of the first light source (1a) and of the second light source (1b) behind the first and second cold-light mirrors (11a, 11b).

16. The illumination apparatus according to claim 10, wherein the computer (4) includes a calibration unit that sets the measured illumination intensity value of a new lamp to a value of 100%, and a threshold value for the light reduction is inputtable to the computer as a percentage.

17. The illumination apparatus according to claim 10, wherein the computer (4) includes a calibration unit that measures the illumination intensity of a new light source and sets it to a previously measured illumination intensity value of an old light source.

18. The illumination apparatus according to claim 10, wherein the computer (4) generates a signal when illumination intensity detected by the at least one light sensor (3a-d) falls below a minimum threshold value or exceeds a maximum threshold value, wherein the signal results in an automatic light source change by way of controlling the first displacement apparatus (25) for the light sources (1a, 1b) or the second displacement apparatus (27) for the light guides.

19. The illumination apparatus according to claim 1, wherein the first light source and the second light source emit light in different spectral bands.

20. The illumination apparatus according to claim 1, further comprising an optical system (119) for delivering the first and second beam paths to the first and second light guides.

21. The illumination apparatus according to claim 1, wherein the first and second light sources (1a, 1b) are carried on a rotatable holding plate (122).

22. The illumination apparatus according to claim 3, further comprising at least one filter (105, 106) positioned in one or both of the first and second beam paths.

23. The illumination apparatus according to claim 22, wherein the at least one filter is positioned between the light source (1a or 1b) and the combining light-guide coupler (109) or after the separating light-guide coupler (111).

24. The illumination apparatus according to one of claims 22, wherein changing of the at least one filter (105, 106) is performable manually.

25. The illumination apparatus according to claim 22, wherein changing of the at least one filter (105, 106) is performable by way of the computer (4) and the electromechanical system (13).

26. The illumination apparatus according to claim 1, wherein the light sources (1a, 1b) are controllable independently of one another.

27. The illumination apparatus according to claim 8, wherein at least one of the first and second light sources (1a, 1b) is usable for a limited time period controlled by the computer (4).

28. The illumination apparatus according to claim 1, wherein at least one of the first and second light sources (1a, 1b) is pulsed.

29. The illumination apparatus according to claim 2, further comprising an illumination handpiece (16) connected to one of the first and second light guides for directly illuminating a viewing field of an optical viewing device.

30. The illumination apparatus according claim 29, wherein the handpiece (16) includes a flexible gooseneck (16a).

31. The illumination apparatus according claim 7, wherein the first and second light sources (1a, 1b) are carried on a first holding plate (122) displaceable relative to the at least one light guide.

32. The illumination apparatus according claim 31, wherein the first holding plate (122) is mounted for rotation about an axis (125).

33. The illumination apparatus according to claim 32, wherein a plurality of filters are carried on a second holding plate mounted for rotation about the axis (125) so that different filters come are selectively positionable after the first and second light sources (1a, 1b).

34. The illumination apparatus according to claim 33, wherein the light entrance ends of the first and second light guides are carried on a third holding plate (124) mounted for rotation about the axis (125).

35. The illumination apparatus according to claim 34, wherein rotation of the holding plates (122, 123, 124) about the axis (125) is controllable manually via combinable rotary knobs (126, 127, 128).

36. The illumination apparatus according to claim 34, wherein rotation of the holding plates (122, 123, 124) about the axis (125) is controllable by way of the computer (4) and the electromechanical system (13).
